(19) United States
(12) Patent Application Publication
(10) Pub. No.: US 2026/0273318 A1
(43) Pub. Date: Sep. 17, 2026

(54) SHIELDED SOFFIT VENT ASSEMBLY

(71) Applicant: Jerome Eisenberg, Boca Raton, FL (US)

(72) Inventors: Jerome Eisenberg, Boca Raton, FL (US); Peter Cordani, Jupiter, FL (US)

(21) Appl. No.: 19/565,075

(22) Filed: Mar. 12, 2026

Related U.S. Application Data
(60) Provisional application No. 63/771,420, filed on Mar. 13, 2025.

(51) Int. Cl. A62C 2/06; E04D 13/152

(52) U.S. Cl. CPC A62C 2/06; E04D 13/152

(57) ABSTRACT

A soffit vent assembly for fire prone areas. The vent assembly can shut off air flow into an attic should fire storm conditions exist. The vent body is constructed from a fire-resistant polymer matrix and includes attachment tabs extending from a first side of the vent body providing fastenerless installation to a soffit opening. A screen within the vent body is formed from the fire-resistant polymer and sized to allow airflow to pass through but configured to prevent debris and pests from passing. A pair of C-shaped channels are formed in said second side of said vent body. A fire-resistant shield is configured to selectively move between an open position allowing airflow and a closed position to obstruct airflow through the vent openings. The shield can be remotely stored or remain attached to the vent body.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 63/771,420, entitled “SHIELDED SOFFIT VENT ASSEMBLY”, filed March 13, 2025; the contents of which are incorporated herein by reference.

### FIELD OF THE INVENTION

The field of the invention is residential and commercial roof construction and, in particular, a soffit vent assembly incorporating a shield.

### BACKGROUND OF THE INVENTION

Roofing materials and the associated construction is critical for the protection of residential and commercial structures. Improvements in roofing materials and construction typically take place due to environmental changes. For instance, the strength and frequency of hurricanes resulted in new building codes. Similarly, the longer dry spells and higher winds of recent years require construction materials that resist wind driven fires. For example, wood shake roofs made from hand-split natural wood shingles were once considered superior roof protection. The wood shake shingles provided natural insulation to keep homes cooler in the summer and warmer in winter, lasting 30–50 years with proper maintenance. However, the increasing threat of wild fires has made such materials obsolete. Some cities and counties (e.g., Los Angeles, San Diego, and other fire-prone regions) completely ban wood shake roofs. The Wildland-Urban Interface (WUI) code in California has strict building codes, particularly in wildfire-prone areas, requiring Class A fire-rated roofing materials. In light of the recent fires in LA driven by 100mph Santa Ana winds, even more stringent fire codes are expected.

Class A ratings indicate the highest level of fire resistance. Class A roofs are designed to withstand direct flame exposure and resist fire for a prolonged period. Such materials are typically concrete, clay tiles, or aluminum construction which is non-combustible making them ideal for fire-prone areas. While the exposed roof may be of class A rating, the underlying support structure, namely the rafters, trusses, joists and decking that support the roofing material may still be wood. On older structures, the support structure may consist of untreated wood. The support structure forms the attic area beneath the roof. Since the support structure is beneath the roof, it would appear safe from wild fires.

While proper roofing material and construction may stop embers from catching the roof decking on fire, if embers enter the attic area where the structure is untreated, the building can burn down. The attic area is most difficult to enter and nearly impossible to extinguish flames once started. Further, the attic of homes may be storage for materials that are not fire resistant.

The soffits, to which this invention pertains, is a most vulnerable portion of the roof due to the soffit vents. Soffit vents help maintain a more moderate attic temperature, reducing heat transfer into living spaces. While a soffit may be constructed from wood, the conventional concern of an ember landing on a soffit is remote since the soffit is on the underside of a roof overhang, arch, or balcony. In residential and commercial buildings, it is most commonly found on the underside of the eaves, bridging the gap between the exterior wall and the edge of the roof. Typically constructed of wood, which may or may not be treated, the orientation being on the underside of the eaves limits the exposure to hot embers from landing on it. However, while a soffit has an aesthetic appeal, it primarily promotes airflow into the attic, reducing moisture buildup and heat accumulation. The soffit vent is covered with a screen-like structure to prevent pests, birds, and debris from getting into the attic.

A most popular soffit vent is a plastic screen that is attached to the soffit without fasteners. A variation of the plastic screen is an aluminum frame that is fastened to the soffit housing a plastic screen. A soffit vent is known to lower the temperature in an attic by promoting natural ventilation by allowing cooler air to enter the attic space to replace hot air trapped inside. Should the roof become hot, such as being subject to a fire storm, air is drawn through the soffit vents in a natural pattern otherwise designed to cool the attic. Soffit vents work in conjunction with ridge vents, gable vents, or roof vents. When hot air rises, it exits through these vents, creating a pressure difference that pulls cooler air through the soffit vents. Unfortunately, during a firestorm the air being drawn into the attic can include hot embers from neighboring fires. This air flow essentially draws the floating embers against the vent screen causing the screen to melt wherein the embers enter the attic. No matter how careful the homeowner is to keep embers off the roof, once an ember bypasses the roof and enters the attic, the probability that the structure will be lost is magnified. A problem during more recent fires is the velocity of the wind that accompanies the fire.

News reports photograph homeowners on their roofs attempting to put out embers. In that moment, the soffit vents are working to the homeowner’s disadvantage as they are drawing air into the attic to cool the structure. It takes just one ember to enter the attic and all the water on the roof is meaningless. Once a fire starts in the attic the homeowner will lose the home.

Like hurricanes, firestorms are partially predictable and citizens that choose to live in hurricane prone areas can guard against the high winds. Structures that have cinder block construction, shatter resistant windows or hurricane panels are likely to resist damage that a non-protected structure may face. Similarly, citizens that choose to live in fire prone areas can guard against certain conditions. Firestorms are more likely to develop when there are high temperatures, low humidity, and strong winds.

Meteorologists can predict conditions that may lead to firestorms using weather models, including predicting the Santa Ana winds which occur when a high-pressure system forms over the Great Basin (Nevada, Utah, and parts of California). Like a hurricane, with sufficient warning homeowners can take steps to protect their structures.

It is also noted that high winds, such as hurricanes, can create a large pressure differential with the attics as wind is fed through the soffit vents.

What is needed in the industry is a device to block the soffit vent when conditions are prone to high winds accompanying a fire or hurricane.

### SUMMARY OF THE INVENTION

Disclosed is a soffit vent assembly formed from a vent body constructed from a fire-resistant polymer matrix including vermiculite and perlite. The vent body includes attachment tabs extending from a first side of the vent body providing fastenerless installation to a soffit opening. A pair of C-shaped channels are formed in said second side of said vent body. A screen within the vent body is formed from the fire-resistant polymer and sized to allow airflow to pass through but configured to prevent debris and pests from passing. A fire-resistant shield is configured to engage said channels and selectively move between an open position allowing airflow and a closed position to obstruct airflow through the vent openings. The shield can be remotely stored or remain attached to the vent structure.

It is an objective of the invention to provide a soffit vent assembly capable of manually shutting off airflow into an attic to mitigate the risk of ember intrusion during firestorm conditions.

Another objective of the invention is to provide a soffit vent assembly capable of manually shutting off airflow into an attic to mitigate the roof damage during hurricane force winds.

Still another objective of the invention is to utilize a fire-resistant polymer matrix for the vent body and integrated screen to ensure durability and resilience against high temperatures and fire exposure.

Yet still another objective of the invention is to provide a fire-resistant vent assembly configured to be a tool-free installation into a soffit opening to simplify installation.

Another objective of the invention is to provide a fire-resistant shield that can selectively move between an open and closed position to regulate airflow based on environmental conditions.

And another objective of the invention is to provide a fire-resistant shield that can either remain attached to the vent structure for immediate deployment or be stored remotely for manual operation when needed.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 is a perspective view of the shielded soffit vent assembly;

FIG. 2A is a top view of the soffit shield;

FIG. 2B is a top view of the soffit vent;

FIG. 3 is a top view of the shied partially covering the soffit vent;

FIG. 4 is an end view of the soffit vent assembly;

FIG. 5A is a top view of a vent body with two screens;

FIG. 5B is a top view of a shield with two apertures;

FIG. 6 is a top view of the shield with passage apertures covering soffit vent screens; and

FIG. 7 is a top view of the shield with passage apertures allowing passage to soffit vent screens.

### DETAILED DESCRIPTION OF THE INVENTION

While the present invention is susceptible of embodiment in various forms, there is shown in the drawings and will hereafter be described a presently preferred, albeit not limiting, embodiment with the understanding that the present disclosure is to be considered an exemplification of the present invention and is not intended to limit the invention to the specific embodiments illustrated.

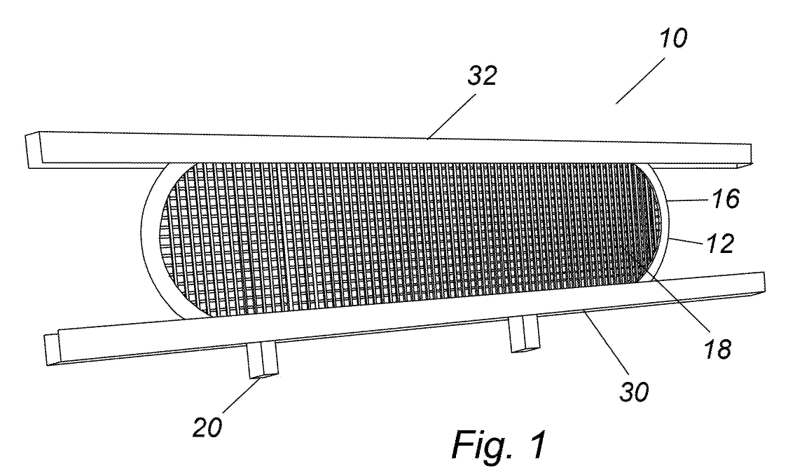

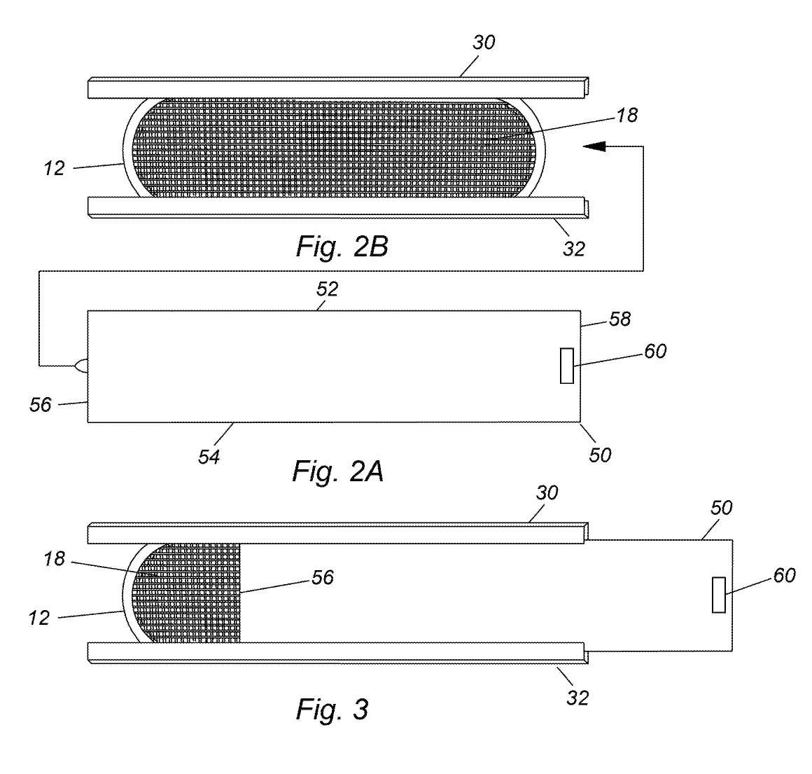

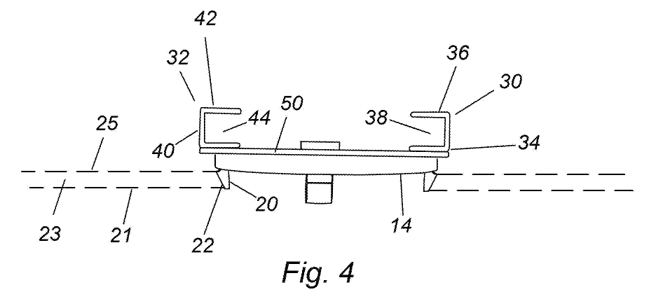

Referring to FIGS. 1-4, illustrated is a soffit vent assembly 10 comprising a vent body 12 having a substantially oblong shape with first side 14 forming a bottom surface and a second side 16 forming a top surface. The vent body 12 is constructed from a fire-resistant polymer matrix containing vermiculite and perlite. The polymer used in the matrix is selected from the group consisting of polycarbonate, polyethylene, polypropylene, or polyvinyl chloride.

A screen 18 is integrated within the vent body 12 and formed from the fire-resistant polymer matrix. In the preferred embodiment, the screen 18 is made integral to the vent body 12 during a manufacturing step. Alternatively, a fire-resistant screen can be secured to the vent body 12. The screen 18 is sized to allow air to pass through the first side 14 and the second side 16 while configured to prevent debris and pests from passing. A plurality of attachment tabs 20 extend from the first side 14 of the vent body 12 allowing for fastenerless installation by engaging with a soffit structure. Each attachment tab 20 includes a boss 22 that extending outward from said attachment tab 20, sized to engage the inner surface 21 of a soffit 23 so as to seal the first side 14 against the outer surface 25 of the soffit 23. The attachment tab 20 may include flexible barbs or other locking elements to secure the soffit vent assembly 10 in place without additional fasteners. The barbs or other locking elements may be a part of the boss 22 of the attachment tab 20.

A pair of C-shaped channels 30, 32 are formed on the second side 16 of the vent body 12. The first C-shaped channel 30 includes a side wall 34 and perpendicular top wall 36 forming an opening 38. Second C-shaped channel 32 includes a side wall 40 and perpendicular top wall 42 forming an opening 44. The openings 38, 44 are opposing and configured to slidably receive a shield 50.

The shield 50 is substantially rectangular having side edges 52, 54 and end edges 56, 58. To facilitate manual sliding of the shield 50, a handle 60 is placed adjacent to at least one end edge 56, 58. The shield 50 is constructed and arranged for slidably engagement of the channel openings 38, 44 and configured to move between allowing airflow through the screen 18 and obstructing airflow through the screen 18. The shield 50 can be constructed from the same fire-resistant polymer matrix material as the vent body 12, or from a thin piece of stainless steel. The objective of the shield 50 is to prevent air flow through the screen 18. In this embodiment, the shield 50 can be removed from the vent body 12 and placed in storage, similar to the storage of hurricane panels when not in their protective service position.

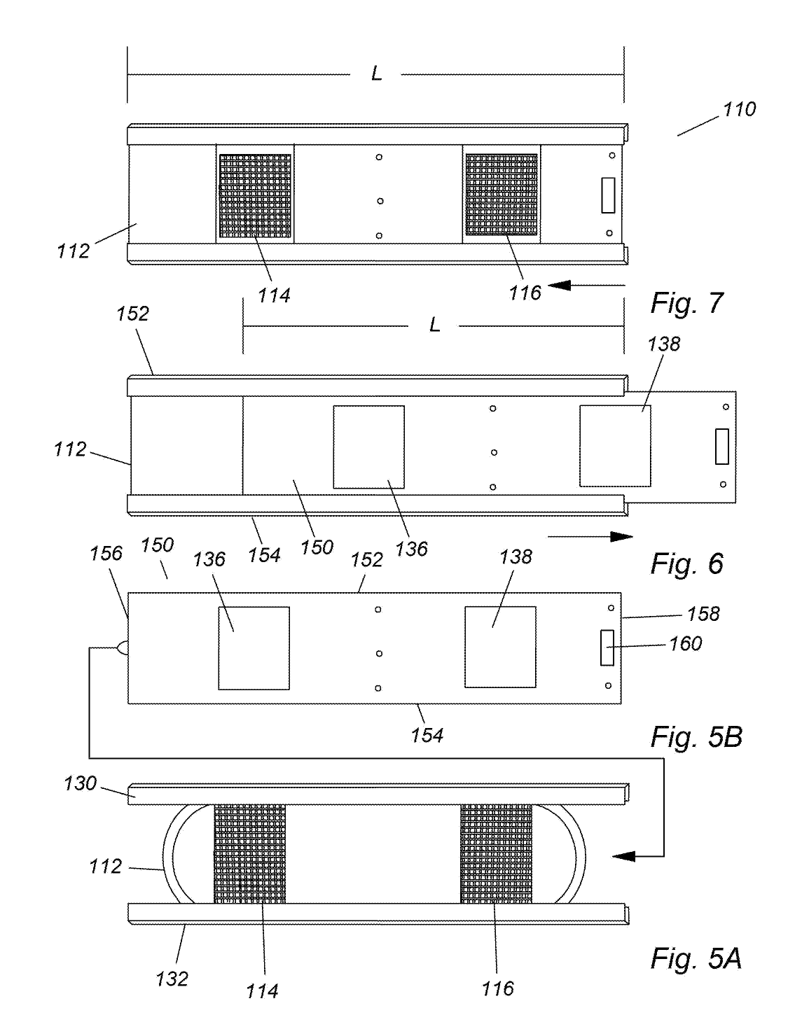

In an alternative embodiment, the shield can remain with the vent body. Referring to FIGS. 5-7, illustrated is a soffit vent assembly 110 comprising a vent body 112 having a substantially oblong shape with a first screen passageway 114 spaced apart from a second screen passageway 116. The vent body 112 is constructed from a fire-resistant polymer matrix containing vermiculite and perlite and the polymer used in the matrix is selected from the group consisting of polycarbonate, polyethylene, polypropylene, or polyvinyl chloride.

The screen passageways 114, 116 are integrated within the vent body 112 and formed from the fire-resistant polymer matrix. Alternatively, fire resistant screens can be secured to the vent body 112. The screens allow air to pass through the vent body 112. Similar to the first embodiment, a pair of C-shaped channels 130, 132 are formed on the vent body 112. The C-shaped channels 130, 132 are opposing and configured to slidably receive a shield 150. The shield 150 is substantially rectangular having side edges 152, 154 and end edges 156, 158. To facilitate manual sliding of the shield 150, a handle 160 is placed adjacent to at least one end edge 156, 158. A first aperture 136 is spaced apart from a second aperture 138 wherein the shield 150 is constructed and arranged for slidably engagement of the channels 130, 132 and configured to move between a position allowing airflow through the screen 114, 116 and obstructing airflow through the screen 114, 116. The shield 150 can be constructed from the same fire-resistant polymer matrix material as the vent body 112, or from a thin piece of stainless steel. FIG. 6 illustrates the shield 150 slid into a position so that the first and second apertures 136, 138 are placed over a portion of the vent body 112 that has no screen. This would be the position of the shield 150 should conditions be right for possible fires. FIG. 7 illustrates the shield 150 slid so that the first and second apertures 136, 138 are place over a portion of the vent body 112 having screens 114, 116. This would be the position of the shield 150 when no fire danger is present. The objective of the shield 150 is to prevent air flow through the screen when fire danger is present. In this embodiment, the shield 150 remains on the vent body 112 for storage as well as application.

The terms "comprise" (and any form of comprise, such as "comprises" and "comprising"), "have" (and any form of have, such as "has" and "having"), "include" (and any form of include, such as "includes" and "including") and "contain" (and any form of contain, such as "contains" and "containing") are open-ended linking verbs. As a result, a method or device that "comprises," "has," "includes" or "contains" one or more steps or elements, possesses those one or more steps or elements, but is not limited to possessing only one or more elements. Likewise, an element of a device that "comprises," "has," "includes" or "contains" one or more features, possesses those one or more features, but is not limited to possessing only those one or more features. Furthermore, a device or structure that is configured in a certain way is configured in at least that way, but may also be configured in ways that are not listed.

One skilled in the art will readily appreciate that the present invention is well adapted to carry out the objectives and obtain the ends and advantages mentioned, as well as those inherent therein. The embodiments described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims.

1. A soffit vent assembly comprising:
a vent body having a substantially oblong shape with a first side and a second side, said vent body constructed from a fire-resistant polymer matrix containing vermiculite and perlite;
a screen integrated within the vent body, the screen formed from the fire-resistant polymer matrix sized to allow airflow to pass through said first side to said second side and configured to prevent debris and pests from passing through;
a plurality of attachment tabs extending from said first side of said vent body, adapted for fastenerless installation by engaging with a soffit structure;
a pair of C-shaped channels formed in said second side of said vent body having opposing openings; and
a shield constructed and arranged for slidably engagement of said channels and configured to move between allowing airflow through said screen and obstructing airflow through said screen.

2. The soffit vent assembly of claim 1, wherein the screen is molded as an integral part of the vent body.

3. The soffit vent assembly of claim 1, wherein the attachment tabs include flexible barbs or locking elements to secure the vent in place without additional fasteners.

4. The soffit vent assembly according to claim 1 wherein said shield is removably attached to said vent body.

5. The soffit vent assembly according to claim 1 wherein said shield is slidably secured to said vent body.

6. The soffit vent assembly according to claim 1 wherein said shield is stainless steel.

7. The soffit vent assembly according to claim 1 wherein said shield is constructed from fire resistant polymer matrix.
